(19) United States
(12) Patent Application Publication
(10) Pub. No.: US 2006/0049615 A1
(43) Pub. Date: Mar. 9, 2006

(54) Portable floor dryer with collapsible handle

(76) Inventor: H. Stephen Day, Mansfield, TX (US)

Correspondence Address: Stephen S. Mosher;Whitaker,Chalk, Swindle & Sawyer, LLP, 3500 City Center Tower II, 301Commerce Street, Fort Worth, TX, 76102-4186, US

(21) Appl. No.: 10/933,568

(22) Filed: Sep. 3, 2004

(51) Int. Cl. B62B 1/00

(52) U.S. Cl. 280/655.1

(57) ABSTRACT

There is disclosed a portable fan for drying floor surfaces, comprising a fan casing and a receiver attached to a rearward outside surface of the fan casing for receiving and storing first and second parallel, telescoping struts of a collapsible handle within first and second parallel wells disposed therewithin; and a collapsible handle having first and second parallel, telescoping struts stored in the first and second wells of the receiver and extendable by pulling upon the collapsible handle or upon release of a latch operated by a button in a handle grip connected between upper ends of the first and second struts of the collapsible handle. In another embodiment, a fixed carrying handle is disposed on a top side of the fan casing and a clearance recess is provided in the underside of the fan casing for receiving the fixed carrying handle of a first portable fan therein when a second portable fan having the clearance recess is stacked on top of the first portable fan having the fixed carrying handle, for transport or storage of the first and second portable fans.

### BACKGROUND OF THE INVENTION

1. Field of the Invention

The present invention generally relates to portable electric fans and, more particularly, to portable electric fans adapted to circulating air or drying surfaces within interior spaces.

2. Description of the Prior Art

Portable electric fans or blowers such as so-called carpet dryers are well-known in the art. Fans of this type are often used in a wide variety of building environments. Frequently, multiple fans are required to accomplish the necessary air circulation or drying operations. Typical applications include drying an interior space damaged by leakage or ingress of water into the space or drying large carpeted areas following a steam cleaning or shampooing operation. In such applications, fans or blowers may be of the centrifugal or axial type and typically have wheels and/or handles enabling them to be easily moved about. For example, U.S. Pat. No. 5,265,895 issued to Barrett, for a “Floor Fan Handtruck Apparatus and Method,” is directed to a centrifugal fan having a housing or casing and a horizontal air outlet, a pair of wheels attached to the casing and a fixed, elongated handle extends upward along the rear of the casing from a point between the pair of wheels, for moving the fan like a two-wheeled hand truck. The fan casing also includes a carrying handle attached to the top of the casing. The cord is stored on a hook attached to the elongated handle. In another example, U.S. Des. Pat. No. D484,586 issued to Intravatola, for the ornamental design of a “Blower,” an axial electric fan is supported by a frame structure that has a pair of wheels attached to a lower part of the frame.

Portable fans typically have one of several kinds of handles to facilitate portability. However, the fixed-length handle taught by Barrett is limited in its utility because the fan cannot readily be used in a crawl space where the elevation is less than about four feet, a common application situation. Further, Barrett's fan is not adaptable to stacking, one on top of the other, for transporting 1- or maneuvering a pair of fans. Moreover, the fan of Intravatola likewise is not adaptable to stacking or for transporting a pair of fans as a compact assembly for ease of maneuvering.

In another field of art, U.S. Pat. No. 2,693,001 issued to Vance, for a “Cord Support For Suction Cleaners,” is directed to a cylindrical-bodied vacuum cleaner having a collapsible “T”-shaped handle that slides in a track along one side of the vacuum cleaner body between a retracted position and an extended position. The cord is supported by a pair of opposing hooks, one fixed to the side of the vacuum cleaner over one end of the track near an upper end of the body and the other hook attached to the lower end of the vertical bar of the “T”-shaped handle. In the retracted position, the opposing hooks retain the cord coiled there-around in a stored position. As the “T”-shaped handle is released from its retracted position and extended, the hook at the lower end of the “T”-shaped handle moves toward the upper hook, reducing the distance between the opposing hooks, thereby releasing the cord from storage. The “T”-shaped handle, when extended may also be used 14 to maneuver the vacuum cleaner about on a pair of wheels attached to the lower end of the body of the vacuum cleaner. However, the “T”-shaped handle, having only a single shaft, is prone to twisting and a loss of control when maneuvering the vacuum cleaner because the handle does not resist the torque imparted thereto while steering the vacuum around an obstacle. Moreover, the vacuum cleaner of Vance is not usable as a fan for circulating air or drying large interior spaces and is also not adapted to stacking or for transporting a pair of devices stacked together.

None of the known prior art portable electric fans or blowers have a torque-resistant, collapsible handle that stores out of the way and, when extended, is readily adapted to transporting or maneuvering stacked fans. Moreover, none of the known fans or blowers disclosed above are adapted to stacking during storage or for transporting a plurality of fans as a compact assembly for ease of maneuvering. What is needed is an electric fan or blower that includes a collapsible handle, is adapted for easily maneuvering in use or in storage, and that enables at least two such fans to be stacked for transport or storage. Such a handle must be sturdy, resistant to torque effects during maneuvering, and easily adjusted, retracted and extended. The fan should be configured for secure stacking of at least two units without additional components or accessories.

### SUMMARY OF THE INVENTION

Accordingly, there is disclosed a portable fan for drying floor surfaces, comprising a fan casing that encloses a rotating fan blade assembly powered by an electric motor operating from power supplied via a power cord; a receiver attached to a rearward outside surface of the fan casing for receiving and storing first and second parallel, telescoping struts of a collapsible handle within first and second parallel wells disposed therewithin, the receiver having a length dimension and an upper end and a lower end of the length dimension; and a collapsible handle having first and second parallel, telescoping struts stored in the first and second wells of the receiver and extendable to a length of at least approximately twice the length of the receiver from the upper end of the receiver upon release of a latch operated by a button in a handle grip connected between upper ends of the first and second struts.

In another embodiment, a fixed carrying handle is disposed in a central location on a top side of the fan casing; and a clearance recess in an underside of the fan casing is provided for receiving the fixed carrying handle of a first portable fan therein when a second portable fan having the clearance recess is stacked on top of the first portable fan having the fixed carrying handle, for transport or storage of the first and second portable fans together.

In another embodiment, first and second wheels are attached to opposite ends of an axle supported by the lower end of the receiver for convenient transport and maneuvering of the fan. The wheels are positioned such that an underside of the fan casing is supported a predetermined distance above a floor surface during operation of the portable fan. First and second feet attached to the underside of the fan casing at respective corners of the fan casing diagonally opposite from each first and second wheel, wherein the first and second feet cooperate with the first and second wheels to support the fan casing a predetermined distance above the floor surface.

### BRIEF DESCRIPTION OF THE DRAWINGS

FIG. 1 illustrates a front side perspective view of one embodiment of a portable fan having a collapsible handle, shown extended, according to the present disclosure;

FIG. 2 illustrates a rear side perspective view of the portable fan of FIG. 1 having a collapsible handle, shown extended, according to the present disclosure;

FIG. 3A illustrates a side profile view of the portable fan of FIG. 1 having a centrifugal type of fan and the collapsible handle, shown retracted, according to the present disclosure;

FIG. 3B illustrates a side profile view of an alternate embodiment of the portable fan of FIG. 1 having an axial type of fan and the collapsible handle, shown retracted, according to the present disclosure;

FIG. 4 illustrates a rear profile view of the portable fan of FIG. 1, the wheels and the collapsible handle, shown retracted, according to the present disclosure;

FIG. 5 illustrates a bottom side view of the portable fan of FIG. 1, including the wheels and the clearance recess formed in the bottom of the casing to accommodate the carrying handle of a like portable fan as in FIG. 1, when the units are stacked one above the other; and

FIG. 6 illustrates a side view of two portable fans according to the present disclosure, one stacked on top of the other as enabled by features of the invention and shown being transported by a worker to a destination.

### DETAILED DESCRIPTION OF THE INVENTION

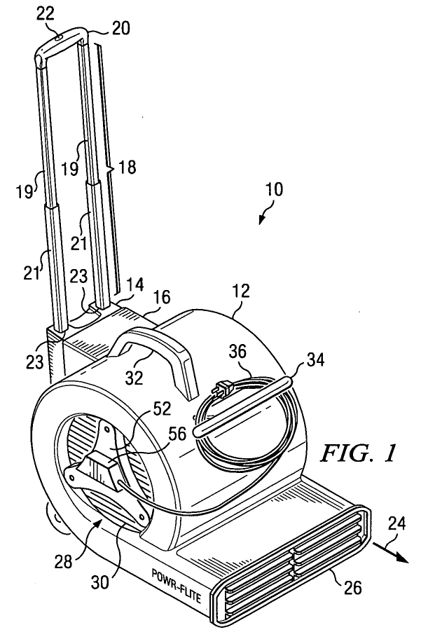

FIG. 1 illustrates a front side perspective view of one embodiment of a portable fan having a collapsible handle, shown extended, according to the present disclosure. The portable fan 10, configured as a centrifugal fan in this view, includes a fan casing 12 that encloses the fan blade and motor assembly (not shown) within a cylindrical, drum-like container. Air is drawn into both ends of the drum-like container, i.e., both sides 28 of the fan casing 12, and expelled centrifugally, i.e., tangentially with respect to the squirrel cage rotor (not shown in FIG. 1) spinning within the fan casing 12, from the air outlet 24. Protruding from a rear side of the fan casing 12 is a stage 16 to which is attached a receiver 14. The receiver 14 provides for the storage and support of a collapsible handle 18 that includes telescoping strut members 19, 21, which may be collapsed within the wells 23 in the receiver 14 by pressing downward on a handle grip 20 connected between upper ends of the telescoping strut members 19. The collapsible handle 18 may be extended into an intermediate or extended position by pulling upon the handle to the desired position. The telescoping struts may be held in any of various predetermined positions by detents (not shown) placed in strategic positions along the telescoping mechanism. Such detents may be spring loaded. Thus, the handle 18 may be retained in a retracted or collapsed, intermediate, or extended position. An operator may override the detent tension merely by moving the collapsible handle 18, i.e., by pulling or pushing upon the collapsible handle 18.

Alternatively, a button 22 may be provided in the handle grip 20 for releasing a latch mechanism (not shown) in the collapsible handle 18 to enable the retraction or collapse of the collapsible handle 18. The collapsible handle 18 maybe configured by an internal spring mechanism to self-extend or retract upon activation of the latch. The receiver 14 for storing the collapsible handle 18 is oriented vertically and disposed as far to the rearward as is practicable to facilitate the stacking of like fans and to orient the collapsible handle in a comfortable position for transport and maneuvering. When the handle is extended, the space between the telescoping struts 19, 21 may be adapted for supporting a warning sign or advertising placard. For example, the corners of such a sign or placard may be attached to fasteners (not shown) which clamp on or otherwise attach, to the adjacent first or second telescoping strut, and are readily detachable therefrom, preferably without the use of tools.

Continuing with FIG. 1, incoming air enters the fan casing 12 through a grill 30 (and a grill 31 on the opposite side of the fan casing 12 as shown in FIG. 2) that may be mounted in both sides 28 of the fan casing 12. The grills 30,31 allow a maximum unimpeded flow of air, prevent the entry of light-weight debris into the fan casing 12, and provide a safety feature preventing contact with the blades when the fan is being operated. Air movement produced by the fan blade within the fan casing 12 is expelled via a vent 26. The vent 26 may include slat members disposed across the air outlet 24 to direct and smooth the air flow. The vent 26 is further configured such that a minimum of obstruction to the flow is provided through openings small enough to limit access by a child's hand, for example. The fan casing 12 may also include a carrying handle 32 on an upper portion of the fan casing 12, positioned so that the handle 32 is directly above the center of mass of the portable fan 10. A cord storage device 34, which may be first and second cord storage hooks mounted in an opposing relationship or the single, molded structure shown in the figure, is used to support a coiled power cord 36 against the upper portion of the fan casing 12.

In the preferred embodiment, the fan casing 12 may be fabricated as a rotomolded high density polyethylene plastic structure. Other materials and fabrication processes are, of course feasible as will be apparent to persons skilled in the art. For example, the method of fabrication may alternatively employ a blow molding process. Polyethylene of high, medium, or low density may be fabricated by either rotomolding or the blow molding process. In yet another alternative embodiment, an injection molding process maybe used wherein the fan casing is formed from ABS or PVC material.

In operation, the portable fan 10 is typically positioned to direct air for drying in a horizontal direction, approximately parallel to the floor. A bail mechanism (not shown) may be attached to the bottom of the fan casing 12 to raise the air outlet vent 24 slightly so that the expelled air stream is directed at an angle relative to the floor surface.

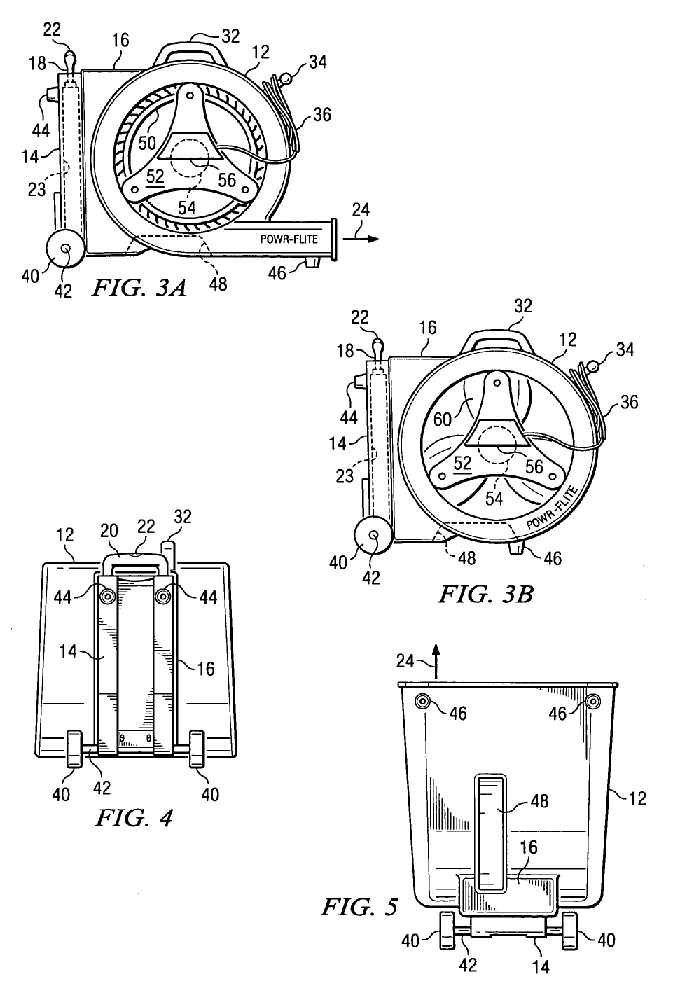

FIG. 2 illustrates a rear side perspective view of the portable fan 10 of FIG. 1 having a collapsible handle 18, shown extended, according to the present disclosure. The view of FIG. 2 is similar to FIG. 1 except that the portable fan 10 has been rotated 180 degrees to show the rear side of the portable fan 10. Accordingly, the structural features of FIG. 2 are similar to those illustrated in FIG. 1 and bear the same reference numbers, with the addition of wheels 40 attached to an axle 42 installed through a lower portion of the receiver 14. Also shown in FIGS. 1 and 2 are brackets 52 and 53 for supporting the assembly of the rotor 50 and the motor/shaft 54, as will be further described in conjunction with FIG. 3.

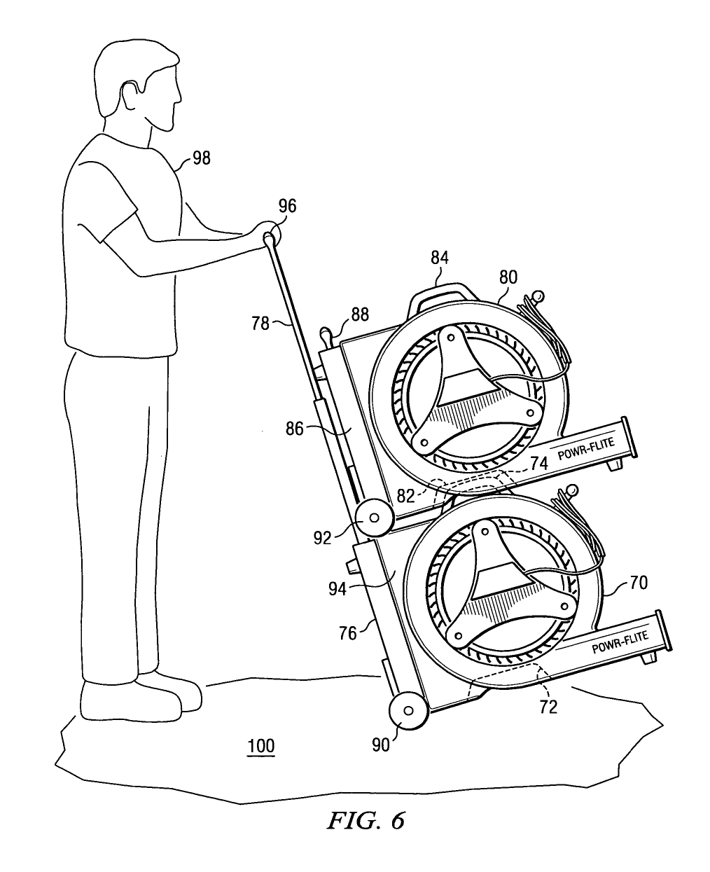

FIG. 3A illustrates a side profile view of the portable fan of FIG. 1 configured as a centrifugal fan having a squirrel-cage type of fan blade and the collapsible handle 18, shown retracted within the wells 23, according to the present disclosure. The grill 30 has been removed from the side of the fan casing 12 in this view so that the fan blade and motor assembly may be seen. A foot 46 is attached to the near side of the underside of the air outlet 24 of the fan casing 12. A second foot (not shown) is located on the other side of the fan casing 12 and is thus not visible in this view. Shown in phantom is the outline of a clearance recess 48 disposed in the bottom of the fan casing 12. As will be described herein below in conjunction with FIG. 6, the clearance recess 48 provides space to receive the carrying handle 32 of a second portable fan 10 when two or more such fans according to the present disclosure are stacked vertically, one above the other.

A squirrel cage fan blade or rotor 50 is shown within the fan casing 12. The drum-like rotor 50, which typically contains a large number of blade elements disposed uniformly around the circumference of the rotor, is supported by and spins on a shaft driven by an electric motor 54, shown in phantom. The assembly of the rotor 50 and the motor 54 (including the motor shaft, not shown) may be supported by the three-spoked bracket 52 attached within the air inlet openings 28 of each side of the fan casing 12. Wiring for the motor 54 is connected to the power cord 36 at a terminal box 56, which may also include, for example, an ON/OFF switch (not shown), a speed control (not shown), and/or a thermal circuit breaker or fuse (not shown). All other structures shown in FIG. 3A are the same as shown in FIGS. 1 and 2 and bear the same reference numbers.

FIG. 3B illustrates a side profile view of a possible alternate embodiment of the portable fan of FIG. 1, configured as an axial fan having a propeller type of fan blade, and the collapsible handle 18, shown retracted within the wells 23, according to the present disclosure. As in FIG. 3A, the grill 30 has been removed from the side 28 of the fan casing 12 in this view so that the fan blade 60 and motor 54 (shown in phantom) may be seen. This embodiment is very similar to the centrifugal fan embodiment of FIG. 3A except that the fan blade 60 is a propeller-type of blade (having three blades in this view), which directs the air outward from the side (facing out of the page) of the fan casing 12 along the axis of the fan blades 60. The air inlet (not shown) for the axial fan is on the opposite side (not shown) of the fan casing 12. The portable fan of FIG. 3B thus does not have the tangential or centrifugal air outlet 24 of FIG. 3A. Although not as quiet running as the centrifugal fan for the same volume of air in cubic feet-per-minute, the propeller-type fan blade of the axial fan is typically less costly to manufacture because of its fewer blade elements. The feet 46 are moved to a position closer to the wheels 40. In all other respects, the portable fan 10 of FIG. 3B is substantially identical with the portable fan of FIG. 3A, with the same structures bearing the same reference numbers.

In the embodiments described and illustrated herein above, an AC powered electric motor 54 is shown for driving the fan 50, 60 (See FIGS. 3A and 3B). It is also possible to drive the fans 50, 60 with DC electric motors from batteries, fuel cells or solar energy conversion devices, or with other types of motors. For example, an internal combustion engine operating on gasoline, liquid (propane) or compressed natural gas as a fuel may be used in some applications. Further, it is even possible to operate the fan 50, 60 with an external combustion engine such as a steam engine fired by burning any of a variety of available fuels. Engines such as these may be more suited to larger fans or fans that would be deployed in situations where noise is a secondary consideration to the power required to deliver the required volume of air.

FIG. 4 illustrates a rear profile view of the portable fan of FIG. 1, the wheels 40 and the collapsible handle 18, shown retracted within the wells 23, according to the present disclosure. Shown in this view are the fan casing 12, and the receiver 14 attached to the stage 16, which protrudes from the rear side of the fan casing 12. The wheels 40 are supported on axle 42, which is installed in the lower end of the receiver 14. A pair of feet 44 are attached to the upper corners of the receiver 14. The handle grip 20, including the release button 22 is shown just above the receiver 14, the collapsible handle 18 (not shown) being fully retracted within the receiver 14. A portion of the carrying handle 32 is shown on the top of the fan casing 12.

FIG. 5 illustrates a bottom side view of the portable fan of FIG. 1, oriented with the air outlet 24 facing upward on the page. The wheels 40 and the clearance recess 48 formed in the bottom of the fan casing 12 (see also FIGS. 3A and 3B) is also visible. The clearance recess 48 is provided to accommodate the carrying handle 32 of a like portable fan 10 as in FIG. 1 when the units are stacked one above the other. Also shown in FIG. 5 is a view of the bottom end of the receiver 14 attached to the stage 16, which is attached to the fan casing 12. The feet 46 shown in FIG. 3A are shown attached to the bottom of the fan casing 12 at each of the forward corners thereof.

FIG. 6 illustrates a simplified side view of two portable fans according to the present disclosure, one stacked on top of the other as enabled by the features of the invention described herein above and shown being transported by a worker 98 to a destination along a floor 100. The lower of the two portable fans, portable fan 70 is shown having a clearance recess 72 and a carrying handle 74 as indicated in phantom. The receiver 76 of portable fan 70 is attached to the casing of the fan 70 by the stage 94. The collapsible handle 78 of the fan 70 is shown fully extended from the receiver 76. The portable fan 70 is shown tilted backward, being held by the operator 98 grasping the handle grip 96, the fan 70 resting on the wheels 90 installed on the receiver 76. The wheels are disposed to roll along the floor 100. A second portable fan 80, identical with the lower fan 70, is shown stacked on top of the lower fan 70. The carrying handle of the lower fan 70 fits within the clearance recess 82 in the bottom of the casing 12 of the second fan 80. The second fan 80 also has a receiver 86. The collapsible handle 88 of the second fan 80 is fully retracted within the receiver 86. The wheels 92 of the second fan 80 straddle the stage 94 of the lower fan 70. The receiver 86 of the second fan 80 rests against the extended collapsible handle 78 of the lower fan 70. In this way a pair of portable fans 10 constructed according to the present disclosure may be stacked for ease of maneuvering or transporting from one place to another by one person. Moreover, it is understood from FIG. 6 that a third fan of like construction (not shown) may be stacked upon the top of the second fan 80 if it is necessary to move three such fans to one location. Further, in a storage location more than three such fans may be stacked because of the configuration of the casing according to the present invention.

While the invention has been shown in only one of its forms, it is not thus limited but is susceptible to various changes and modifications without departing from the spirit thereof.

What is claimed is:

1. A portable fan for drying floor surfaces, comprising:
a fan casing that encloses a rotating fan blade assembly powered by a motor;
a receiver attached to a rearward outside surface of the fan casing for receiving and storing first and second parallel, telescoping struts of a collapsible handle within first and second parallel wells disposed therewithin, the receiver having a length dimension; and
a collapsible handle having first and second parallel, telescoping struts stored in the first and second wells of the receiver and extendable to a length beyond the receiver of at least approximately twice the length of the receiver upon release of a latch.

2. The portable fan of claim 1, further comprising:
first and second wheels attached to opposite ends of an axle supported by the lower end of the receiver such that an underside of the fan casing is supported a predetermined distance above a floor surface during operation of the portable fan.

3. The portable fan of claim 2, wherein the fan casing further comprises:
first and second feet attached to the underside of the fan casing at respective corners of the underside of the fan casing diagonally opposite from each first and second wheel, wherein the first and second feet cooperate with the first and second wheels to support the fan casing a predetermined distance above the floor surface.

4. The portable fan of claim 1, wherein the portable fan is a centrifugal fan driven by a motor, wherein further:
the rotating fan blade within the fan casing is a squirrel cage rotor having a plurality of blades; and
air exits from the fan casing tangentially from an outer diameter of the rotor through an outlet extending from a front side of the fan casing.

5. The portable fan of claim 4, wherein the motor is selected from the group consisting of electric motor, internal combustion engine and external combustion engine.

6. The portable fan of claim 1, wherein the portable fan is an axial fan driven by a motor, wherein further:
the rotating fan blade within the fan casing is a propeller having at least two fan blades; and
air exits from the fan casing along the axis of rotation of the propeller.

7. The portable fan of claim 6, wherein the motor is selected from the group consisting of electric motor, internal combustion engine and external combustion engine.

8. The portable fan of claim 1, wherein the fan casing comprises:
a fixed carrying handle disposed on a top side of the fan casing; and
a clearance recess in an underside of the fan casing for receiving a fixed carrying handle of a first portable fan therein when a second portable fan having the clearance recess is stacked on top of the first portable fan having the fixed carrying handle, for transport or storage of the first and second portable fans.

9. The portable fan of claim 1, wherein the fan casing further comprises:
at least first and second cord storage hooks disposed apart and oriented in opposite directions along a common line on the upper portion of the front side of the fan casing for supporting and storing a power cord formed into a coil around the first and second cord storage hooks.

10. The portable fan of claim 9, wherein the first and second cord storage hooks are 25 combined into a single cleat attached in a horizontal orientation on the upper portion of the front side 26 of the fan casing.

11. The portable fan of claim 1, wherein:
the receiver, configured as a rectangular box having a depth dimension substantially less than a width dimension that is substantially less than the length dimension defined between upper and lower ends of the receiver, is attached to the rearward outside surface of the fan casing; and
the first and second parallel wells, open at upper ends thereof, are disposed along and within respective opposite first and second sides of the receiver, the first and second wells being further oriented parallel to the length dimension of the receiver.

12. The portable fan of claim 1, wherein the collapsible handle further comprises:
a latch operated by a button in a handle grip connected between upper ends of the first and second struts.

13. The portable fan of claim 12, wherein the handle grip of the collapsible handle comprises:
a spring-loaded button disposed in a side of the handle grip that is operable upon pressing the spring-loaded button to release the latch that secures the collapsible handle in a retracted position within the receiver.

14. The portable fan of claim 1, wherein the collapsible handle further comprises:
a spring-loaded detent in each first and second telescoping strut for retaining each first and second telescoping strut in an intermediate or extended position; wherein
the spring-loaded detent in each first and second telescoping strut may be overridden by moving the handle grip of the collapsible handle toward a closed or open position to retract or extend respectively the collapsible handle.

15. The portable fan of claim 1, wherein the collapsible handle is configured to self-extend into an intermediate or extended position upon release of the latch.

16. The portable fan of claim 1, wherein the collapsible handle may be pulled into an intermediate or extended position upon release of the latch.

17. The portable fan of claim 1, wherein the collapsible handle may be pushed from an intermediate or extended position into a collapsed position upon release of the latch.

18. The portable fan of claim 1, wherein the collapsible handle may be retracted from an intermediate or extended position into a collapsed position upon release of the latch.

19. The portable fan of claim 1, wherein the fan casing is fabricated from polyethylene material using a rotomolding process or a blow molding process.

20. The portable fan of claim 19, wherein the polyethylene material may be high, medium, or low density polyethylene.

21. The portable fan of claim 1, wherein the fan casing is rotomolded of high density polyethylene.

22. The portable fan of claim 1, wherein the fan casing may be fabricated from an ABS material or a PVC material using an injection molding process.

23. The portable fan of claim 1, further comprising means for supporting a warning sign or advertising placard in the space between the first and second telescoping struts.

24. A portable fan for drying floor surfaces, comprising:
a fan casing that encloses a rotating fan blade assembly powered by a motor;
a receiver attached to a rearward outside surface of the fan casing for receiving and storing first and second parallel, telescoping struts of a collapsible handle within first and second parallel wells disposed therewithin, the receiver having a length dimension; and
a collapsible handle having first and second parallel, telescoping struts stored in the first and second wells of the receiver and extendable to a length beyond the receiver of at least approximately twice the length of the receiver by pulling upward upon a handle grip connected between upper ends of the first and second struts.

25. The portable fan of claim 24, further comprising:
first and second wheels attached to opposite ends of an axle supported by the lower end of the receiver such that an underside of the fan casing is supported a predetermined distance above a floor surface during operation of the portable fan.

26. The portable fan of claim 25, wherein the fan casing further comprises:
first and second feet attached to the underside of the fan casing at respective corners of the underside of the fan casing diagonally opposite from each first and second wheel, wherein the first and second feet cooperate with the first and second wheels to support the fan casing a predetermined distance above the floor surface.

27. The portable fan of claim 24, wherein the portable fan is a centrifugal fan driven by a motor, wherein further:
the rotating fan blade within the fan casing is a squirrel cage rotor having a plurality of blades; and
air exits from the fan casing tangentially from an outer diameter of the rotor through an outlet extending from a front side of the fan casing.

28. The portable fan of claim 27, wherein the motor is selected from the group consisting of electric motor, internal combustion engine and external combustion engine.

29. The portable fan of claim 24, wherein the portable fan is an axial fan driven by a motor, wherein further:
the rotating fan blade within the fan casing is a propeller having at least two fan blades; and
air exits from the fan casing along the axis of rotation of the propeller.

30. The portable fan of claim 29, wherein the motor is selected from the group consisting of electric motor, internal combustion engine and external combustion engine.

31. The portable fan of claim 24, wherein the fan casing comprises:
a fixed carrying handle disposed in a central location on a top side of the fan casing; and
a clearance recess in an underside of the fan casing for receiving a fixed carrying handle of a first portable fan therein when a second portable fan having the clearance recess is stacked on top of the first portable fan having the fixed carrying handle, for transport or storage of the first and second portable fans.

32. The portable fan of claim 24, wherein the fan casing further comprises:
at least first and second cord storage hooks disposed apart and oriented in opposite directions along a common line on the upper portion of the front side of the fan casing for supporting and storing a power cord formed into a coil around the first and second cord storage hooks.

33. The portable fan of claim 32, wherein the first and second cord storage hooks are combined into a single cleat attached in a horizontal orientation on the upper portion of the front side of the fan casing.

34. The portable fan of claim 24, wherein:
the receiver, configured as a rectangular box having a depth dimension substantially less than a width dimension that is substantially less than the length dimension defined between the upper and lower ends of the receiver, is attached to the rearward outside surface of the fan casing; and
the first and second parallel wells, open at upper ends thereof, are disposed along and within respective opposite first and second sides of the receiver, the first and second wells being further oriented parallel to the length dimension of the receiver.

35. The portable fan of claim 24, wherein the collapsible handle further comprises:
a latch operated by a button in a handle grip connected between upper ends of the first and second struts.

36. The portable fan of claim 35, wherein the handle grip of the collapsible handle comprises:
a spring-loaded button disposed in a side of the handle grip that is operable upon pressing the spring-loaded button to release the latch that secures the collapsible handle in an extended position.

37. The portable fan of claim 24, wherein the collapsible handle further comprises:
a spring-loaded detent in each first and second telescoping strut for retaining each first and second telescoping strut in a retracted position; wherein
the spring-loaded detent in each first and second telescoping strut may be overridden by pulling the handle grip of the collapsible handle toward an open position to extend the collapsible handle.

38. The portable fan of claim 24, wherein the collapsible handle is configured to self-extend into an intermediate or extended position upon release of a latch.

39. The portable fan of claim 24, wherein the collapsible handle may be pulled into an intermediate or extended position upon release of a latch.

40. The portable fan of claim 24, wherein the collapsible handle may be pushed from an intermediate or extended position into a collapsed position upon release of a latch.

41. The portable fan of claim 24, wherein the collapsible handle may be retracted from an intermediate or extended position into a collapsed position upon release of a latch.

42. The portable fan of claim 24, wherein the fan casing is fabricated from polyethylene material using a rotomolding process or a blow molding process.

43. The portable fan of claim 24, wherein the polyethylene material may be high, medium, or low density polyethylene.

44. The portable fan of claim 24, wherein the fan casing is rotomolded of high density polyethylene.

45. The portable fan of claim 24, wherein the fan casing may be fabricated from an ABS material or a PVC material using an injection molding process.

46. The portable fan of claim 24, further comprising means for supporting a warning sign or advertising placard in the space between the first and second telescoping struts.
